(19) United States
(12) Patent Application Publication
(10) Pub. No.: US 2011/0226752 A1
(43) Pub. Date: Sep. 22, 2011

(54) ELECTRIC GRILL FOR FOOD COOKING

(76) Inventor: Andrea Biondi, Rimini (IT)

(21) Appl. No.: 13/129,347

(22) PCT Filed: Nov. 12, 2009
(86) PCT No.: PCT/IT2009/000506

§ 371 Date: May 13, 2011

(30) Foreign Application Priority Data
Nov. 17, 2008 (IT) AN2008A000048

(51) Int. Cl. H05B 3/68

(52) U.S. Cl. 219/429

(57) ABSTRACT

A substantially vertical electric grill for cooking food is described. A frame is provided that contains and supports a substantially vertically positioned electric heat source and a means for accommodating the food to be cooked.

### CROSS REFERENCE TO RELATED APPLICATIONS

The present application is the US national stage of International Application PCT/IT2009/000506 filed on Nov. 12, 2009, which in turn, claims priority to Italian Patent Application No. AN2008A000048 filed on Nov. 17, 2008. The present application may be related to U.S. Ser. No. 29/367,321, filed on Aug. 5, 2010 and entitled “ELECTRIC GRILL”, also incorporated by reference in the present application.

### TEXT OF THE DESCRIPTION

The present invention relates to food-cooking devices, and particularly it relates to electrical grills.

Devices for cooking food on grids, skewers and similar supports are known and generally referred to as grills, which can comprise a traditional heat source, i.e. wood embers or charcoal, or an electrically powered heat source such as resistors, infrared lamps or the like.

There are a wide variety of such devices according to the scopes of utilization, especially if they are intended for a professional or domestic use, and according to the food to be cooked. A most important common problem is the dripping of cooking fats, of course when cooking meats on the heat source, which leads to the formation of very harmful substances such as benzopyrene K having a carcinogenic potential, as well as nitrosoamines.

Therefore, it is important to think about a way to make cooking systems which can prevent cooking juices from contacting the heat source; a feasible solution which is already available in the prior art involves the construction of a vertically arranged device, i.e. a device wherein the grid is arranged on a plane parallel to the heat source, which is in turn perpendicular to the support plane of the device. This makes it possible to prevent the above-described problem of generating harmful substances derived from the smokes which develops during cooking, but at least two noticeable drawbacks arise. First, it becomes necessary to make a practical and effective system for connecting the removable grids to their support, and since the support has a vertical arrangement, the same grids has also to be secured to it in some way; furthermore, the food at the downwardly-facing end of the grid are wetted by juices and fats in a greater extent than the food at the upwardly-facing end.

Therefore, the aim of the present invention is to provide a device which can overcome the above-outlined drawbacks, making it possible to arrange the cooking grid(s) on suitable support means in a simple and stable manner while reducing the effects of percolation of juices from one food to another along the length of said grids.

Hence, the object of the present invention is an electrical grill for cooking food, comprising a heat source arranged on a substantially vertical plane, i.e. perpendicular to the rest plane of said device, said heat source being powered by electric power, and a support frame for means intended to accommodate the food under cooking, characterised in that said support frame comprises support members for said food-accommodating means, said support members being arranged in such a way that said accommodating means is placed on an inclined plane relative to the plane of said heat source, and a support base on said rest plane.

Advantageously, said support members can support the food-accommodating means on both sides of the heat source. In a preferred embodiment, said support members comprise two members having a substantially trapezoidal peripheral shape, which are connected to each other and arranged on planes which are parallel to each other and perpendicular to the plane of said heat source. Said members are arranged with the major base facing the rest plane of said device.

Preferably, a removable tray is provided to collect juices resulting from cooking food, said removable tray being appropriately accommodated on said support members and arranged parallel to the rest plane. The heat source is removably fitted on said support frame, and means are provided to support it.

In another embodiment, said grill is further provided with at least one screen member, removably connected to said support frame, whose side facing the heat source is able to reflect heat. Advantageously, said screen member includes a tray provided with a ?coating of a diathermic material on the side facing outwardly. Furthermore, said tray can be provided with housing means for skewers and the like, such as the food prepared by the grill according to the invention can be directly served on the table.

Preferably the heat source—generally an electrical resistor provided with an adjusting assembly and powering means—will be made removable from the support frame such as it can also be directly cleaned in the dishwasher.

Other advantages and features of the device according to the present invention will be apparent from the following description of an embodiment thereof, which is provided by way of illustration, and not by way of limitation, with reference to the accompanying drawings, wherein:

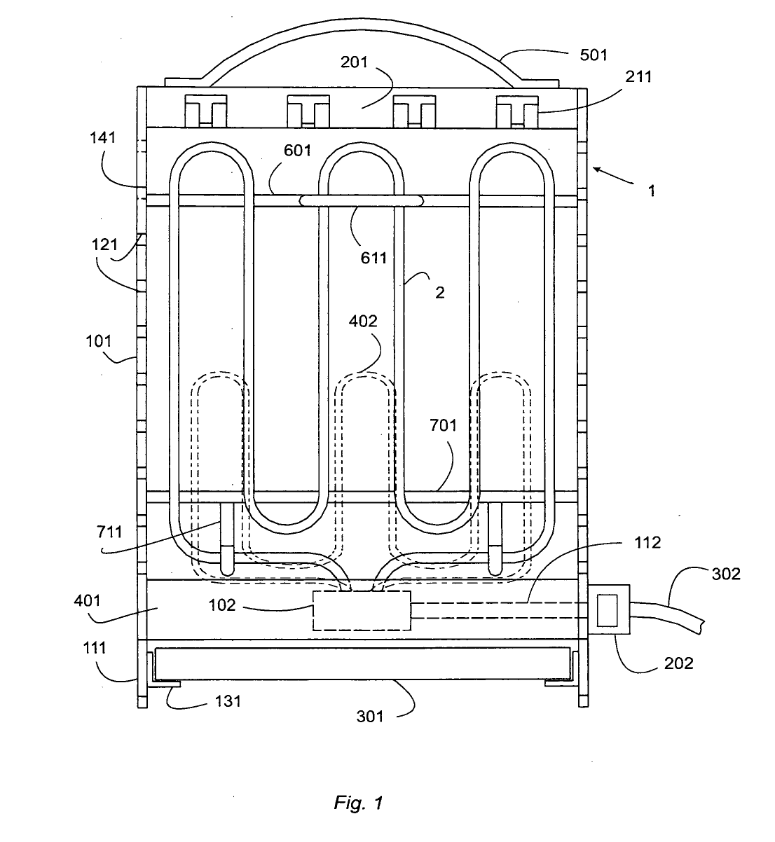

FIG. 1 is a front elevation view of a first embodiment of the device according to the present invention;

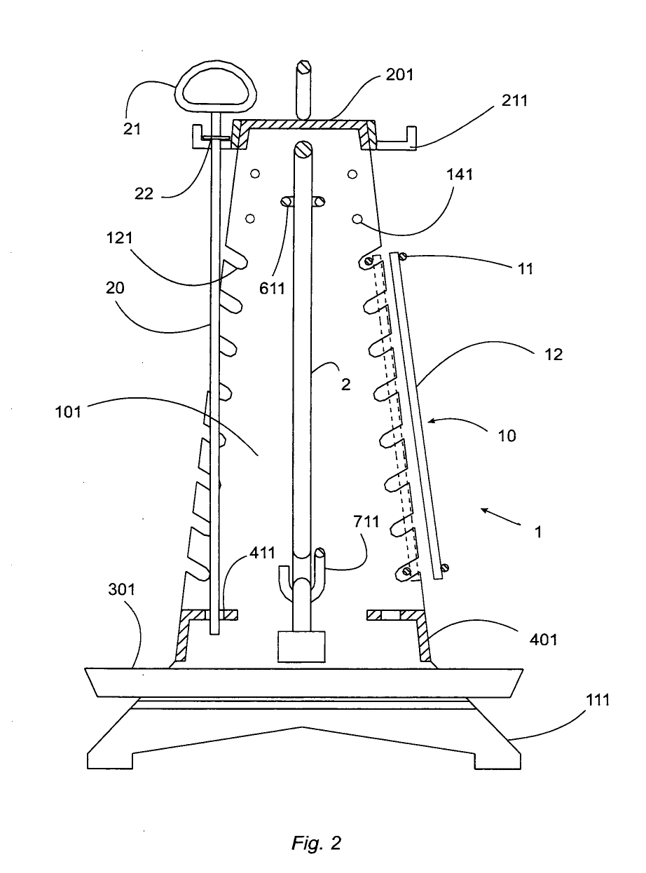

FIG. 2 is a longitudinal section view of the device as shown in FIG. 1;

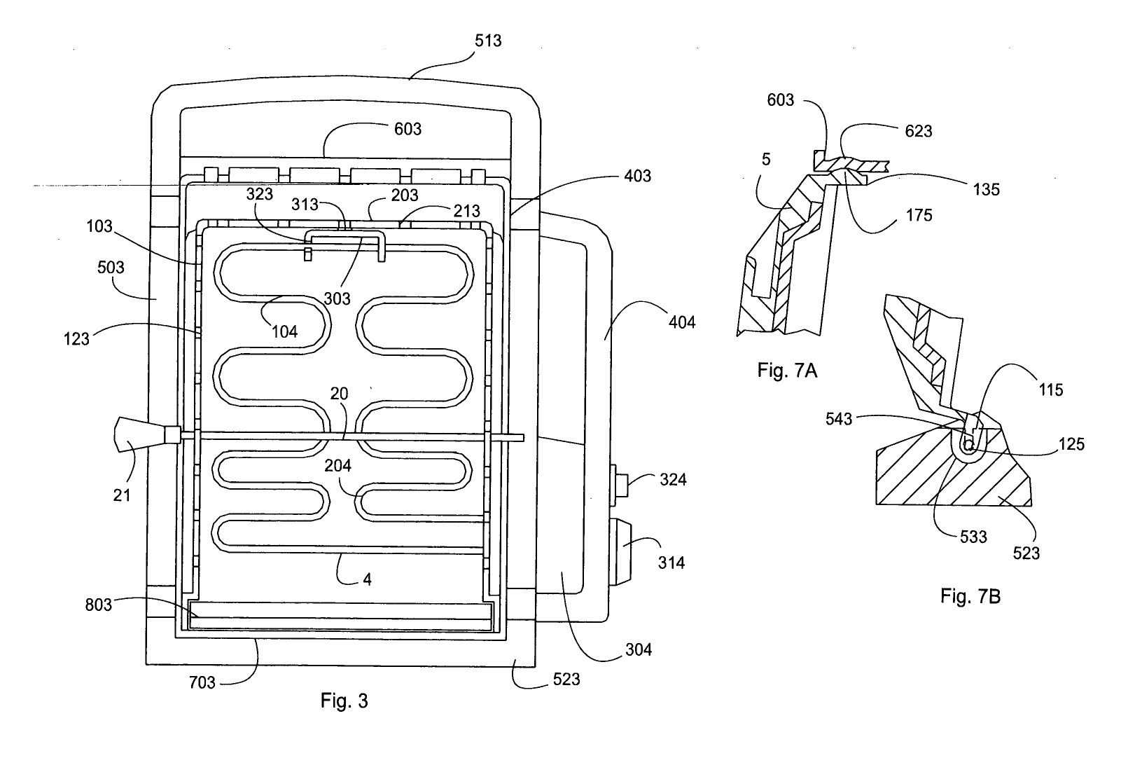

FIG. 3 is an elevation view of a second embodiment of the device according to the invention;

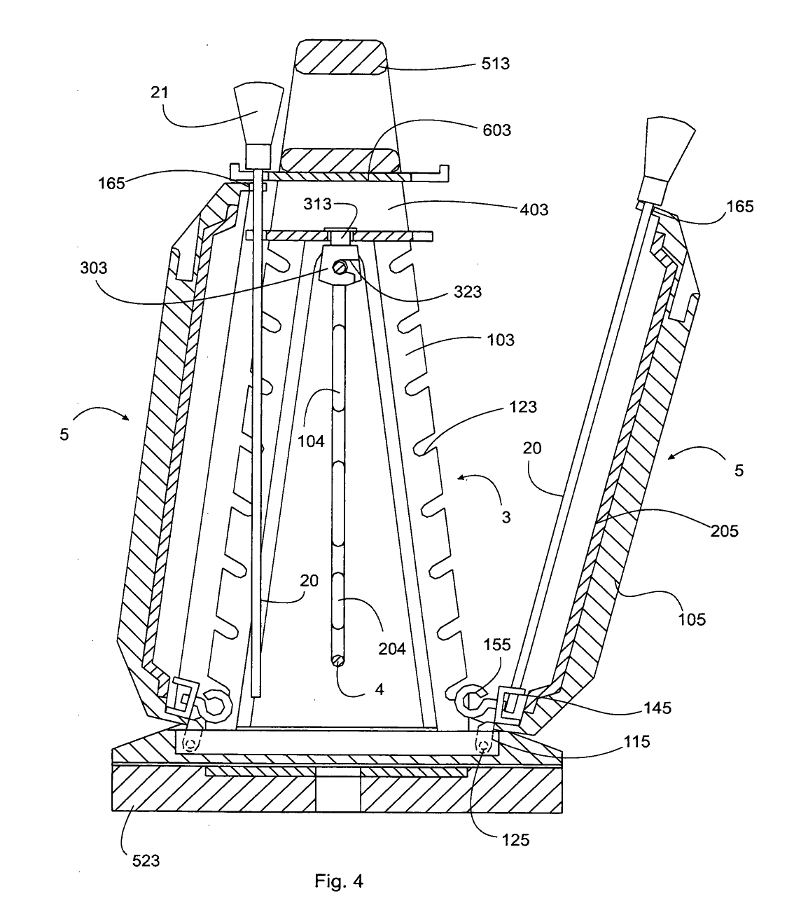

FIG. 4 is a longitudinal section view of a variant embodiment of the device of FIG. 3;

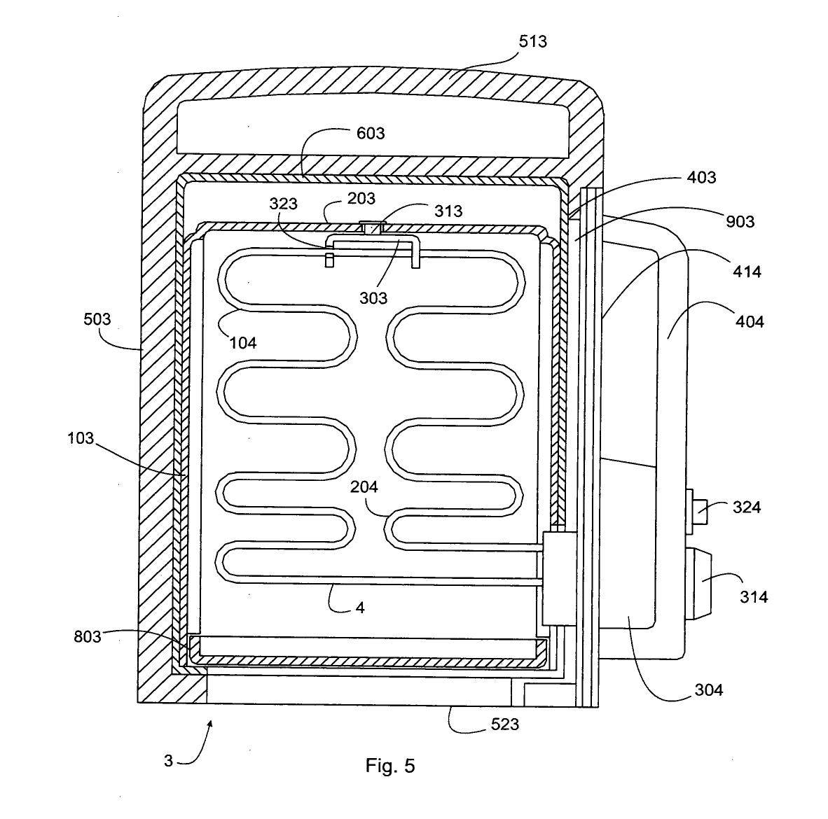

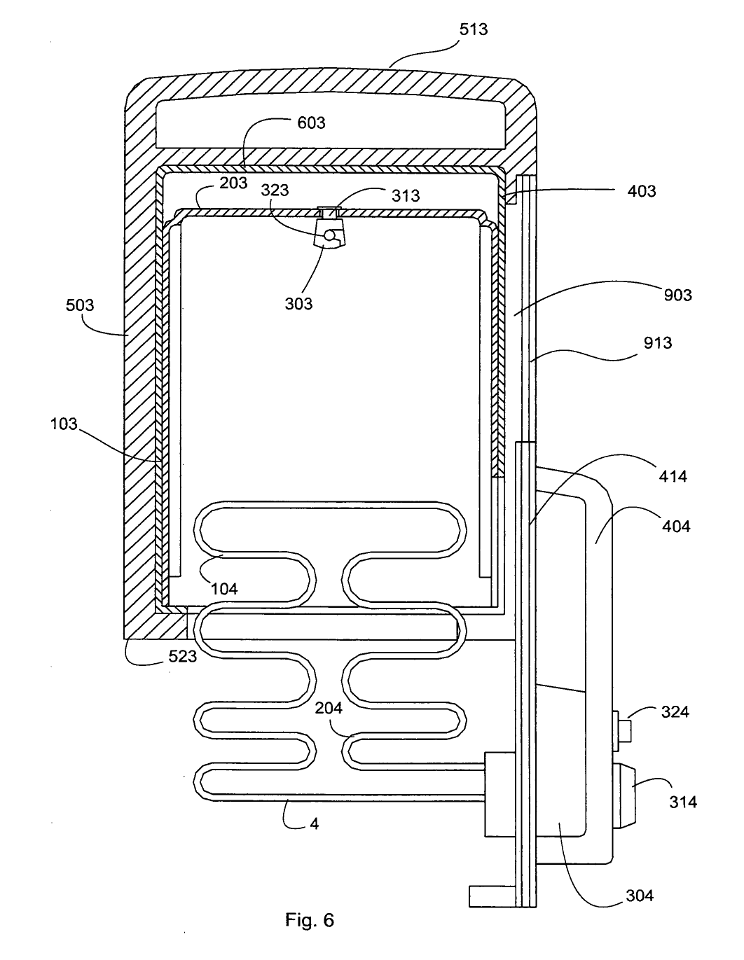

FIGS. 5 and 6 are two partially sectioned views of the device of FIG. 3;

FIGS. 7A and 7B are two sectioned and enlarged details of the embodiment as shown in FIG. 3;

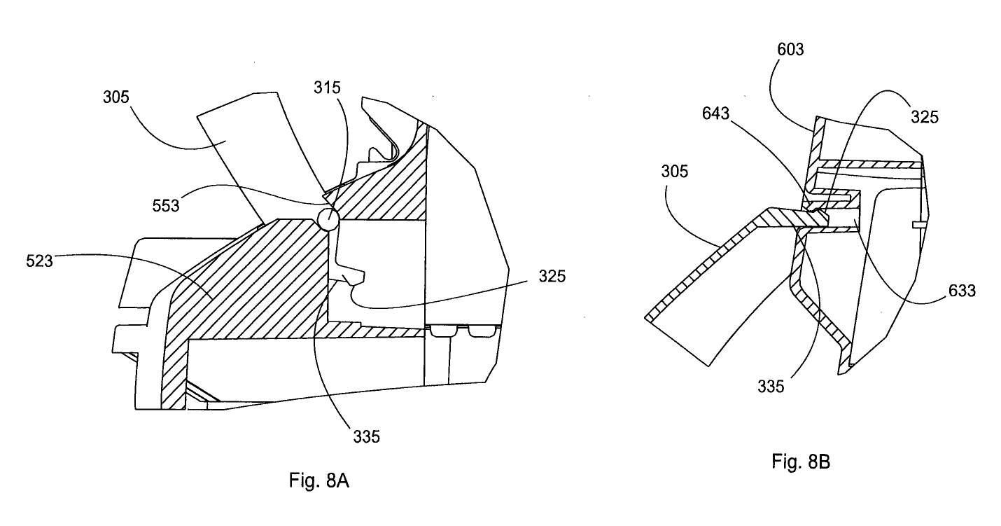

FIGS. 8A and 8B are variant embodiments of the embodiment as shown in FIGS. 7A and 7B.

FIG. 1 shows an electrical grill according to the present invention; reference numeral 1 denotes the support frame for the means to accommodate the food to be cooked. Said frame includes two plates 101 arranged on planes which are parallel to each other and perpendicular to the plane whereon the heat source lies, which heat source is the electrical resistor 2 as illustrated herein. Both the plates 101 are connected by a crossbar 201 at the upper ends thereof and by sections 401 at the lower ends thereof, as better seen with reference to FIG. 2. The crossbar is also provided with a handle 501.

Both the plates rest on the rest plane by means of feet 111, and each of them is provided with a guide 131 in which a tray 301 is removably inserted at the face of the plate facing the inside of said frame 1. The frame 1 also includes a bar 601 spanning across the frame and providing support through a ring 611, the resistor 2 and a bar 701 having hooks 711 to support the resistor 2 at the other end relative to the ring 611.

The ends of the resistor 2 are connected to a block 102 which, through a stem 112, is connected to a switch 202 which in turn connects the resistor 2 to a power cable 302. In the figure there is shown, in dot-and-dash lines, an optional resistor which can engage only the lower portion of the device.

Along the side edges of both the plates 101 there are formed a plurality of notches 121 which are equally spaced to each other and symmetrically arranged with respect to the notches formed on the opposite plate; in the first two rows of one of the two plates there are formed holes 141 instead of notches 121, as shown in dash line in the figure. On the contrary, the crossbar 201 has formed cantileverly protruding housings 211 whose function will be better apparent from the following.

FIG. 2 shows the device of the present invention in a longitudinal section thereof; like numerals correspond to like parts. In the figure there is shown the food-accommodating means which utilizes the support frame 1 in a different manner. Indeed, the grid 10 is positioned with its perimetric transverse elements 11 which are accommodated into the notches 121 formed on the edge of the plate 101, and the food is interposed among the plurality of longitudinal elements 12. In the upper portion of the plate 101 there are formed through holes 141 instead of notches 121. On the opposite side of the plate 101 a skewer 20, which is provided with a handle ring 21 and a stop flange 22, is disposed between the housing 211 cantileverly projecting from the crossbar 201 and the through holes 411 formed in the sections 401. In the figure it is possible to clearly notice the slope of the plane on which the grid 10 is positioned with respect to the plane of the resistor 2.

FIG. 3 shows a second embodiment of the device according to the present invention; in this case the support frame 3, which is preferably made of a plastics material, includes a pair of uprights 503, a base 523 and an upper handle element 513. The plates 403 are abutted against the uprights 503, are they are connected to each other through the crossbar 603 at the end facing the handle 513, and through a baseplate 703 at the end facing the base 523. Mounting supports 103 and the crossbar 203 are arranged further inside than the baseplate 703; a removable tray 803 is arranged on the base plate 703 to collect the cooking juices. The supports 103 have notches 123 intended to accommodate skewers 20 which are in turn provided with handle means 21, i.e. a grid (not shown in the figure). The resistor 4, which is positioned within the internal area of the device and provided with coils 104 and 204 of different sizes, is connected at its ends to a power supply, drive and control assembly 304, which has a handle 404, adjustment means 314 and turning on/off means 324. The portion of the resistance toward the crossbar 203 is connected to the same through a substantially U-shaped coupling member 303 which is provided at the arms thereof with two notches 323 intended to accommodate the resistor 4 itself. The member 303 is rotatably pivoted to the crossbar 203 through a pin 313 as better described in the following.

FIG. 4 shows the embodiment of FIG. 3 in a variant thereof; like numerals correspond to like parts; in the figure it can be seen that two trays 5 are introduced, each comprising a shield of a metallic material facing the inside of the device, and a coating of a diathermic material, such as for example a plastics material, facing outwardly. As is readily apparent from the figure, both the trays can accommodate skewers 20 through housings 145 and 165 formed in the edges of the corresponding opposite ends. The housings 145 are also provided with skewer-blocking means. The trays can be secured to the structure of the device, and they can be moved to a close position, i.e. with the coupling means 135 coupled to the crossbar 603, or to an open position. The end facing the base 523 of the device is coupled through a limb 115 and a pin 125 projecting from said limb.

FIG. 5 shows the device of FIG. 3 in a longitudinal section; like numerals correspond to like parts. As can be noted, the frame 3 has a seat 903 in which there is positioned the base 414 of the control assembly 304 connected to the resistor 4.

As shown in FIG. 6, said base is slidably drawn along the guides 913 until the resistor and the control assembly 304 are removed. In order to remove such assembly, the coupling member 303 has been suitably rotated through 90° around the pin 313 to release the resistor from the notches 323 of the same member.

FIGS. 7A and 7B show in detail the coupling system of the trays 5 to the support frame. As already mentioned, the end of the tray 5 connecting to the base 523 has a limb 115 with a pin 125 radially projecting therefrom; said pin is fitted into a slot 543 formed within a recess 533. At the opposite end of the tray 5, a limb 135 co-acts with a recess 623 formed in the crossbar 603 through a relief 175.

Finally, FIGS. 8A and 8B show a variant embodiment of the coupling system of the trays to the support frame. In this case, the tray 5 has, at the angle ends thereof, projecting legs 305 which are substantially identical to each other and provided with both a radially projecting pin 315 able to co-act with the slot 553 of the base 523, as can be seen in FIG. 8A, and a limb 335 provided with a relief 325 adapted to co-act with the recess 633 formed in the crossbar 603 and provided with the corresponding tooth relief 643, as can be seen in FIG. 8B.

The operation of the device according to the present invention will become apparent from the following. As apparent from FIG. 2, when a grid 10 is loaded with food to be cooked (not shown in the figure), it can be positioned on the support frame 1, i.e. the transverse elements 11 of the grid are fitted into the appropriate notches 121 formed in the plates 101. In this way, because of the inclination imparted to the edge of the plate 101, the connection appears to be very simple, and the grid will be easily positioned without special shrewdness.

In the upper portion of one of the two plates there are formed through holes 141 instead of notches 121; this allows to use such positions to insert metallic skewers as well as wooden skewers thereto. Indeed, such through holes can be preferably formed in the lower portion of one of the two plates, and preferably from the lower half to near the rest feet 111. These holes serve to make the coupling more stable, especially with wooden skewers;

preferably the hole is less than 5 mm and preferably less than 4 mm in diameter.

Of course, the same task can be accomplished by notches having a smaller diameter than those intended to accommodate the transverse elements of the grid, and preferably they have a diameter of about 4-5 mm as described above for the holes.

The slope selected for the side walls of the plates 101 forming the support members of the grids to be positioned on the device of the invention depends on several factors which has to be weighted in order to obtain the optimal result. According to a first approximation, it can be said that it is preferred a slope from 7° to 30° with respect to the plane on which the heat source, i.e. the resistor 2, lies; it is considered that a slope smaller than 7° abrogates de facto the potential benefits of an improved stability of the coupling of the grids and a diminished percolation of juices onto the food which is more closely positioned to the lower end. Vice versa, a slope greater than 30° greatly emphasizes the difference of exposure of the two ends of a grid to heat. It is apparent that the most juices leaking from the food under cooking, especially fats, will fall onto the tray 301 instead of onto the underlying food with a suitable slope, preferably a slope in the range from 10° and 20°.

In order to prevent the difference of thermal radiation at the two ends of the devices, as shown in FIG. 1, it is possible to provide an auxiliary resistor 402 arranged in the lower portion of the device to increase the heat scattered at this position, so as to compensate for the increased distance between the grid and the heat source itself. This auxiliary heat source can be activated independently from the main source so as to allow a choice with respect to the evenness of the heat transmitted to the food under cooking. All the electrical portion of the device is removably mounted with respect to the support frame such as the latter can be easily cleaned, even in a dishwasher. To this end, the trapezoidal plates 101 are advantageously made as a single piece of stainless steel or the like, while the crossbar 201, the sections 401 and the bars 601 and 701 can be also made of soldered stainless steel or otherwise connected to said plates 101.

The housings 211 and the holes 411 allowing the skewers 20 to be positioned are shown disposed in such a way that the skewers are oriented along a direction which is parallel to the heat source, but said skewers can also be conveniently inclined with respect to said plane.

With reference to the embodiment shown in FIGS. 3 to 7B, the heat source, i.e. the resistor 4, has been conveniently connected to the control assembly 304 in such a way that the same is completely positioned at a side of the supports intended to accommodate the grids or skewers; in contrast with the solution shown in FIG. 1, in this case the ends of the resistor are prevented to be exposed to liquids draining out during cooking. Furthermore, as can be seen in FIGS. 5 and 6, the control assembly 304 and the resistor 4 can be easily removed from the support frame 3, which can be than completely cleaned, even in a dishwasher. The resistor is attached, at the portion thereof facing the end of the support frame having the handle, through a member 303 provided with suitable coupling notches which does not interfere with the extraction of the resistor itself once it is rotated.

A great advantage is also achieved by the variant embodiment shown in FIG. 4, which uses two trays 5 disposed on both sides of the heat support structure. Indeed, since the trays includes an internal wall of a thermal-reflective material, typically a metallic material such as stainless steel or the like, they act as shields to retain the heat generated by the resistor while reflecting it onto the food to be cooked, resulting in reduced processing times for the same food.

Furthermore, their shape enables also two further uses; first, they can be used to maintain already-cooked food warm simply spacing the same tray by swinging, as in the case exemplified in FIG. 4. Advantageously, the coupling system as employed allows to insert and remove the tray (see FIG. 7A) when the tray is disposed in an orthogonal position with respect to the base 523, while the coupling cannot be released when the same tray is inclined. Once the coupling of the tray to the support structure is released, the tray can be readily used as a serving dish. Advantageously, the tray has an external coating of a diathermic material to allow the tray to be handled with no risk of burn as well as to prevent the irradiation of the heat, and than the dispersion thereof.

1. An electric grill for cooking food, comprising:
a heat source arranged on a substantially vertical plane, said heat source adapted to be powered by electrical power; and
a support frame for means to accommodate food to be cooked, said support frame comprising support members for said means to accommodate food, said support members being arranged in a way such that said means to accommodate food is placed on an inclined plane relative to the substantially vertical plane of said heat source; and
a support base on a resting plane.

2. The electric grill according to claim 1, wherein said support members are adapted to support said means to accommodate food on both sides of the heat source.

3. The electric grill according to claim 2, wherein said support members comprise two support members having a substantially trapezoidal peripheral shape which are connected to each other and arranged on planes parallel to each other and perpendicular to a plane of said heat source.

4. The electrical grill according to claim 3, wherein said members are arranged with a major base facing the resting plane of said electric grill.

5. The electric grill according to claim 3, wherein said support members further comprises a plurality of notches intended to support said means to accommodate food along slanted sides of said means to accommodate food.

6. The electric grill according to claim 3, wherein one of said two support members has two or more through holes.

7. The electric grill according to claim 6, wherein said two or more through holes are less than 8 mm, and preferably less than 4 mm in diameter.

8. The electric grill according to claim 1, further comprising a removable tray to collect juices as a result of cooking food, said removable tray being positioned in said support frame and arranged parallel to the resting plane.

9. The electric grill according to claim 1, further comprising means for supporting the heat source, wherein the heat source is removably positioned on said support frame and the means for supporting heat source.

10. The electric grill according to claim 9, wherein said means for supporting heat source comprises:
a first bar positioned adjacent a top end of the support frame opposite the resting plane, said first bar being integral to said support frame and arranged transversely to the support frame, the first bar comprising a ring at a substantially central position thereof which cooperates with said heat source; and
a second bar positioned adjacent an opposite end of the support frame, said second bar being arranged transversely to said support frame, the second far comprising one or more support hooks facing the resting plane.

11. The electric grill according to claim 9, wherein said means for supporting said heat source comprises a second support member rotatably fitted on said frame, said second support member comprising a coupling means to said heat source, said second support member being rotatable from an interference position to a non-interference position.

12. The electric grill according to claim 9, wherein said heat source is coupled to a drive and control assembly, the drive and control assembly being removably and longitudinally slidably mounted on one of said support members, said support members comprising a guiding means.

13. The electric grill according to claim 1, further comprising an auxiliary heat source, the auxiliary heat source being located adjacent to the end of said support frame facing said resting plane.

14. The electric grill according to claim 1, wherein said heat source is configured to transmit an increased amount of heat to a portion facing said resting plane.

15. The electric grill according to claim 1, wherein said heat source is an electric resistor.

16. The electric grill according to claim 1, wherein said means to accommodate food is positioned on a slope, wherein the slope ranges from 7° to 30°, and preferably from 10° to 20°, with respect to a plane of said heat source.

17. The electric grill according to claim 1, further comprising at least one screen member removably connected to said support frame, wherein a side of the at least one screen member facing the heat source is adapted to reflect heat.

18. The electric grill according to claim 17, wherein said at least one screen member comprises a metallic material portion facing said heat source, and a diathermic material portion facing outwards.

19. The electric grill according to claim 17, wherein said screen member further comprises a plurality of housings to house said means to accommodate food.

20. The electric grill according to claim 17, wherein said screen member is swingably connected to said support frame.
